(19) United States
(12) Patent Application Publication
(10) Pub. No.: US 2013/0027416 A1
(43) Pub. Date: Jan. 31, 2013

(54) GATHER METHOD AND APPARATUS FOR MEDIA PROCESSING ACCELERATORS

(71) Applicants: Karthikeyan Vaithianathan, Little Rock, AR (US); Bhargava G. Reddy, Bangalore (IN)

(72) Inventors: Karthikeyan Vaithianathan, Little Rock, AR (US); Bhargava G. Reddy, Bangalore (IN)

(21) Appl. No.: 13/189,663

(22) Filed: Jul. 25, 2011

(51) Int. Cl. G09G 5/36

(52) U.S. Cl. 345/557

(57) ABSTRACT

Apparatus, systems and methods are described including dividing cache lines into at least most significant portions and next most significant portions, storing cache line contents in a register array so that the most significant portion of each cache line is stored in a first row of the register array and the next most significant portion of each cache line is stored in a second row of the register array. Contents of a first register portion of the first row may be provided to a barrel shifter where the contents may be aligned and then stored in a buffer.

### BACKGROUND

Video surfaces are typically stored in memory in a tiled format to improve memory controller efficiency. Video processing algorithms frequently require access to 2D region of interest (ROI) of arbitrary rectangular sizes at arbitrary locations within these video surfaces. These arbitrary locations may be cache unaligned and may span over several non-contiguous cache lines and/or tiles. In order to gather pixels from such locations, conventional approaches may over fetch several cache lines of pixel data from memory and then perform swizzling, masking and reduction operations making the gather process challenging.

Power efficient media processing is typically done by either a programmable vector or scalar architectures, or by fixed function logic. In conventional vector implementations, pixel values for a ROI may be gathered using vector gather instructions that often involve collecting some values of a row of pixel values from one cache line, masking any invalid values, storing the values in either a buffer or memory, collecting additional pixel values for the row from the next cache line, and repeating this process until a complete horizontal row of pixel values are gathered. As a result, to accommodate tiling formats, typical vector gather processes often require reissuing the same cache line multiple times using different masks.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example system;

FIG. 2 illustrates an example process;

FIG. 3 illustrates an example tile memory format;

FIG. 4 illustrates an example tile memory format;

FIGS. 5, 6 and 7 illustrate the example system of FIG. 1 in various contexts;

FIG. 8 illustrates additional portions of the example process of FIG. 2;

FIG. 9 illustrates the example system of FIG. 1 in overflow conditions; and

FIG. 10 is an illustrative diagram of an example system, all arranged in accordance with at least some implementations of the present disclosure.

### DETAILED DESCRIPTION

One or more embodiments are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such system-on-a-chip (SoC) architectures for example, implementation of the techniques and/or arrangements described herein are not restricted to particular architectures and/or computing systems and may implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described herein.

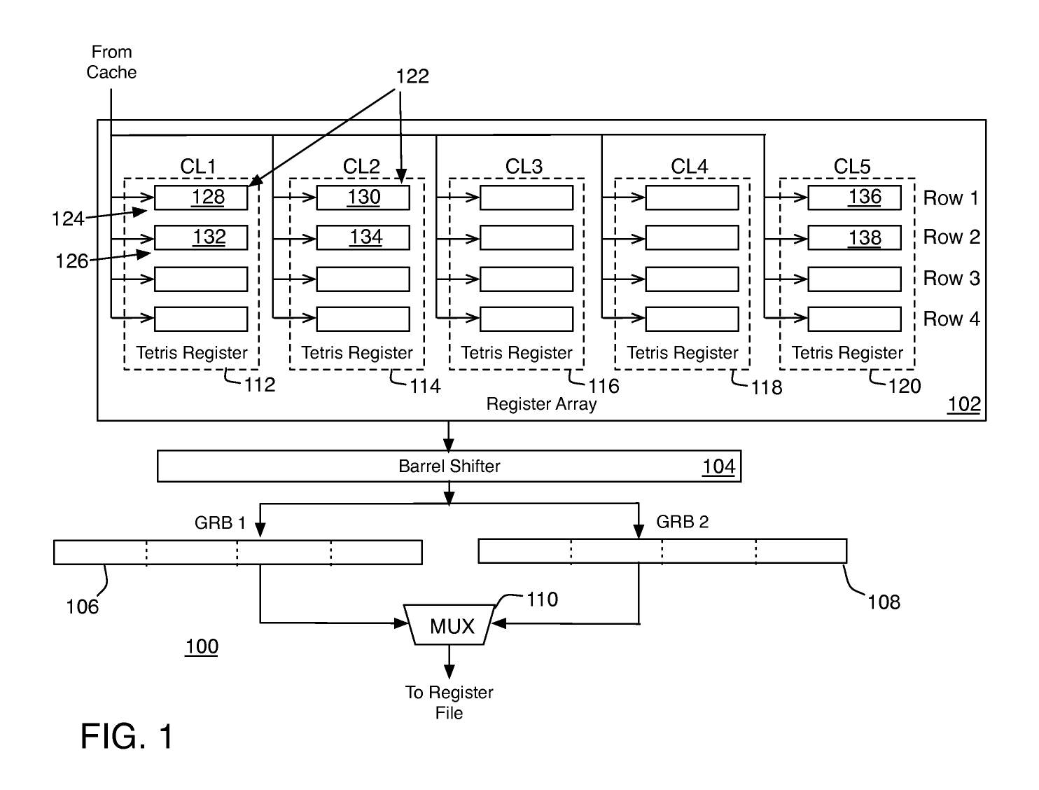

FIG. 1 illustrates an example implementation of a gather engine 100 in accordance with the present disclosure. In various implementations, gather engine 100 may form at least a portion of a media processing accelerator. Gather engine 100 includes a register array 102, a barrel shifter 104, two gather register buffers (GRB) 106 and 108, and a multiplexer (MUX) 110. Register array 102 includes multiple tetris registers 112, 114, 116, 118 and 120 having multiple register storage locations or portions 122. In various implementations, tetris registers in accordance with the present disclosure may be any temporary storage logic such as processor register logic configured to be byte marked or enabled.

In accordance with the present disclosure, gather engine 100 may be used to gather video data from a region of interest (ROI) of a video surface stored in memory such as cache memory (e.g., L1 cache memory). In various implementations, the ROI may include any type of video data such as pixel intensity values and so forth. In various implementations, engine 100 may be configured to store the contents of multiple cache lines (CLs) received from cache memory (not shown) so that each cache line (e.g., CL1, CL2, etc.) is stored across the portions 122 of a corresponding one of tetris registers 112-120 of array 102. In various implementations, the first portions of the tetris registers may form a first row 124 of array 102, while the second portions of the tetris registers may form a second row 126 of the array, and so on.

In accordance with the present disclosure, cache line contents may be stored in array 102 so that different portions of the contents of each CL are stored in different portions of a corresponding one of the tetris registers. For example, in various implementations, a most significant portion of CL1 may be stored in a first portion 128 of tetris register 112, while a most significant portion of CL2 may be stored in a first portion 130 of tetris register 114, and so on. A next most significant portion of CL1 may be stored in a second portion 132 of tetris register 112, while a next most significant portion of CL2 may be stored in a second portion 134 of tetris register 114, and so on.

In accordance with the present disclosure, the number of rows of array 102 may match the number of octal words (OWs) in the cache lines to be processed, while the number of columns of array 102 (and hence the number of tetris registers employed) may match the number of cache line OWs plus one. In the example of FIG. 1, engine 100 may be configured to gather 64 byte cache lines so that each tetris register includes four portions 122 to store the four 16 byte OW portions of a corresponding cache line and hence array 102 includes four rows. For example, the most significant OW of CL1 may be stored in portion 128 of tetris register 112, while the next most significant OW of CL1 may be stored in portion 132 of register 112, and so forth. As will be explained in greater detail below, to accommodate and process misaligned and/or overflow cache line contents, gather engines in accordance with the present disclosure may include at least one more tetris register than the number of tetris registers required to store cache line OWs. For example, for processing 64 byte cache lines having four OWs, array 102 includes five tetris registers 112-120 so that each row of array 102 spans a total of 80 bytes in width.

Barrel shifter 104 may receive the contents of any one of the rows of register 102. For example, barrel shifter 104 may be a 64 byte barrel shifter configured to receive the contents of row 124 corresponding to the most significant portions of the five cache lines stored in array 102. In various implementations, as will be explained in greater detail, barrel shifter 104 may align the contents of register portions 122 by, for example, left shifting them, and then may supply the aligned contents to GRB 106 or GRB 108. For example, barrel shifter 104 may, in successive iterations, receive the contents of portions 122 of row 124, align those contents and provide the aligned contents to GRB 106. For instance, barrel shifter 104 may receive the contents of register portion 128, may align those contents and then provide the aligned data to GRB 106. Barrel shifter 104 may then receive the contents of register portion 130, may align those contents and then provide the aligned data to GRB 106 to be temporarily stored adjacent to the aligned data corresponding to register portion 128, and so on until the contents of row 124 are aligned with and stored in GRB 106 to create an aligned row of pixel data.

While engine 100 is processing the contents of row 124 as just described, engine 100 may also undertake processing the contents of row 126 in a similar manner until the contents of row 126 are aligned with and stored in GRB 108 to create a second aligned row of pixel values. In various implementations, as will be explained in greater detail below, GRBs 106 and 108 may provide aligned rows of pixel data to a 2D register file (not shown) in a ping pong fashion using MUX 110 to alternately provide the contents of GRBs 106 and 108 to the register file (RF).

In various implementations, gather engine 100 may be implemented in one or more integrated circuits (ICs) such as, for example, a system-on-a-chip (SoC) and additional ICs of consumer electronics (CE) media processing system. For example, engine 100 may be implemented by any device configured to process video data, such as, but not limited to, an Application Specific Integrated Circuit (ASIC), a Field Programmable Gate Array (FPGA), a digital signal processor (DSP), or the like. As noted above, while engine 100 includes five tetris registers 112-120 suitable for processing 64 byte cache lines, gather engines in accordance with the present disclosure may include any number of tetris registers depending on size of the cache line and/or ROI being processed.

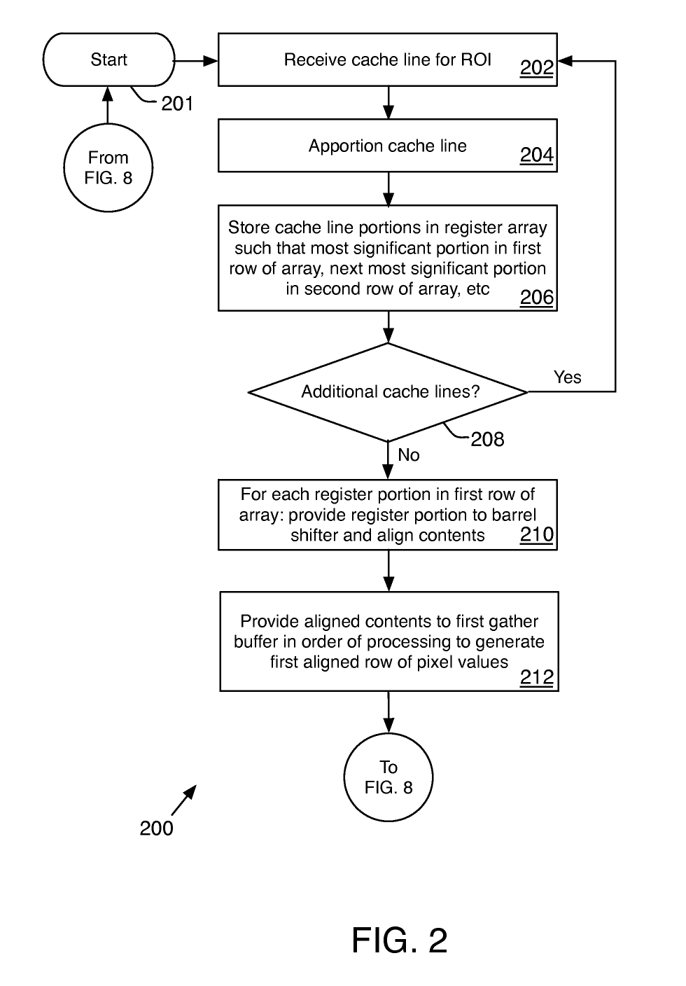

FIG. 2 illustrates a flow diagram of an example process 200 for implementing gather operations according to various implementations of the present disclosure. Process 200 may include one or more operations, functions or actions as illustrated by one or more of blocks 201, 202, 204, 206, 208, 210, and 212 of FIG. 2. By way of non-limiting example, process 200 will be described herein with reference to example gather engine 100 of FIG. 1. Process 200 may begin at block 201 with the start of a gather process for a ROI of a video surface. For example, process 200 may begin at block 201 with the start of gather processing for a 64×64 ROI (e.g., an ROI spanning sixty-four rows, each row having sixty-four bytes of pixel values).

At block 202, a first cache line (CL) may be received where the CL corresponds to first CL of data included in the ROI. At block 204 the CL may be apportioned into a most significant portion, a next most significant portion, and so forth. For example, if a 64 byte CL is received at block 202, the CL may be apportioned into four 16 byte OW portions. The CL portions may then be loaded into a register array so that the most significant portion is stored in the first position of the first row of the array, the next most significant portion in the first position of the second row of the array, and so on. For instance, a 64 byte CL (CL1) received by array 102 may be apportioned into four OWs and loaded into the register portions 122 of the first tetris register 112 so that the most significant OW is stored in portion 128, the next most significant OW is stored in portion 132, and so forth.

At block 208 a determination may be made as to whether additional cache lines of data are to be obtained for the ROI. If additional CLs are to be obtained then process 200 may loop back and blocks 202-206 may be undertaken for the next CL in the ROI. For instance, a next 64 byte CL (CL2) may be received by array 102, apportioned into four OWs and loaded into the register portions 122 of the second tetris register 114 so that the most significant OW is stored in portion 130, the next most significant OW is stored in portion 134, and so on. In this manner, process 200 may continue to loop through successive iterations of blocks 202-206 until one or more additional CLs of the ROI are loaded in array 102. For instance, continuing the example from above, up to three more CLs of the ROI (e.g., CL3, CL 4 and CL5) may be received by array 102, apportioned into four OWs and loaded into the register portions 122 of the remaining tetris registers 116, 118 and 120 in a similar manner.

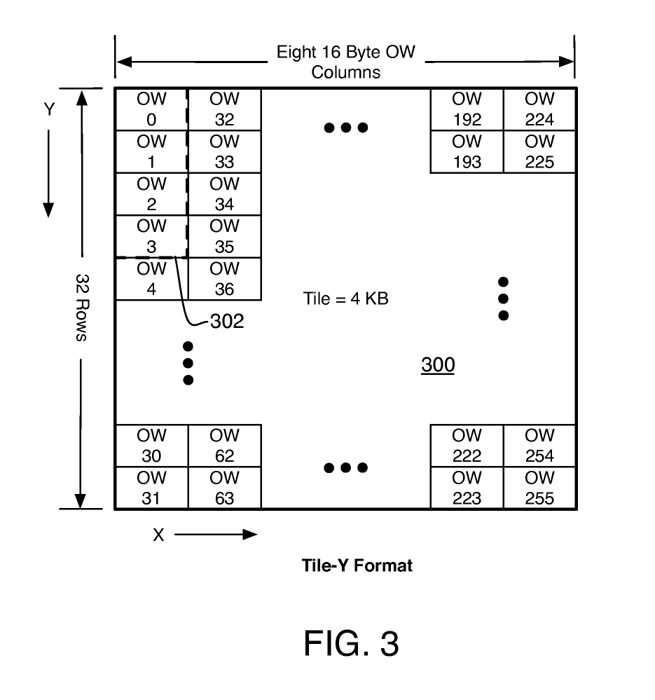

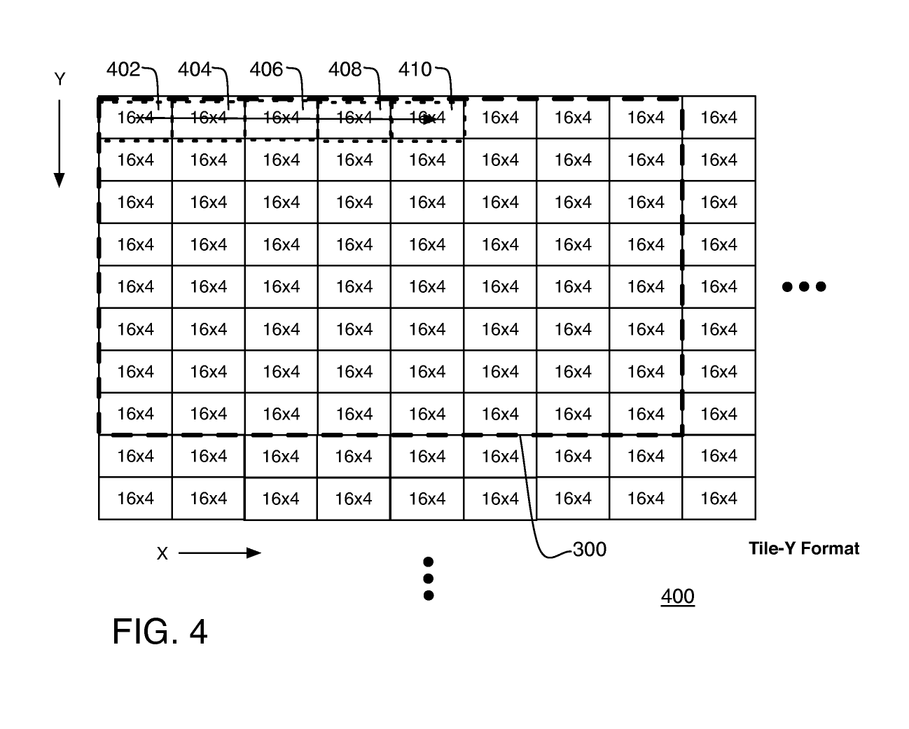

FIGS. 3 and 4 illustrate example tile-y formats for storage of video surfaces in tiled memory in accordance with various implementations of the present disclosure. In FIG. 3, a 4 KB tile 300 of memory may include eight (8) columns by thirty-two (32) rows of 16 byte wide storage locations. In tile-y format, tile 300 may store the four OWs of a 64 byte CL 302 as a first portion of a column of tile 300. In this manner, tile 300 may store sixty-four (64) cache lines of data. In FIG. 4, tile 300 is shown spanning part of a region 400 of memory such as cache memory. Referring the process 200 and engine 100, successive iterations of block 202-206 to load CLs of a ROI may include successively loading cache lines 402-410 of tile 300 into array 102.

Returning to discussion of FIG. 2, when one or more CLs of the ROI have been loaded into the register array, process 200 may continue at block 210 with, for each successive portion of the first row of the array, loading the portion into the barrel shifter and, if necessary, aligning the contents of the portion. For example, block 210 may include loading the contents of first portion 128 of row 124 in shifter 104 and then left shifting the data to align it with GRB 106. In some implementation, block 210 may not include aligning the contents if the cache lines are already aligned when loaded into the array at blocks 202-206. At block 212, the aligned first row of pixel values may be provided to a first gather buffer. For example, the aligned pixel value contents of row 124 may be provided from barrel shifter 104 to GRB 106.

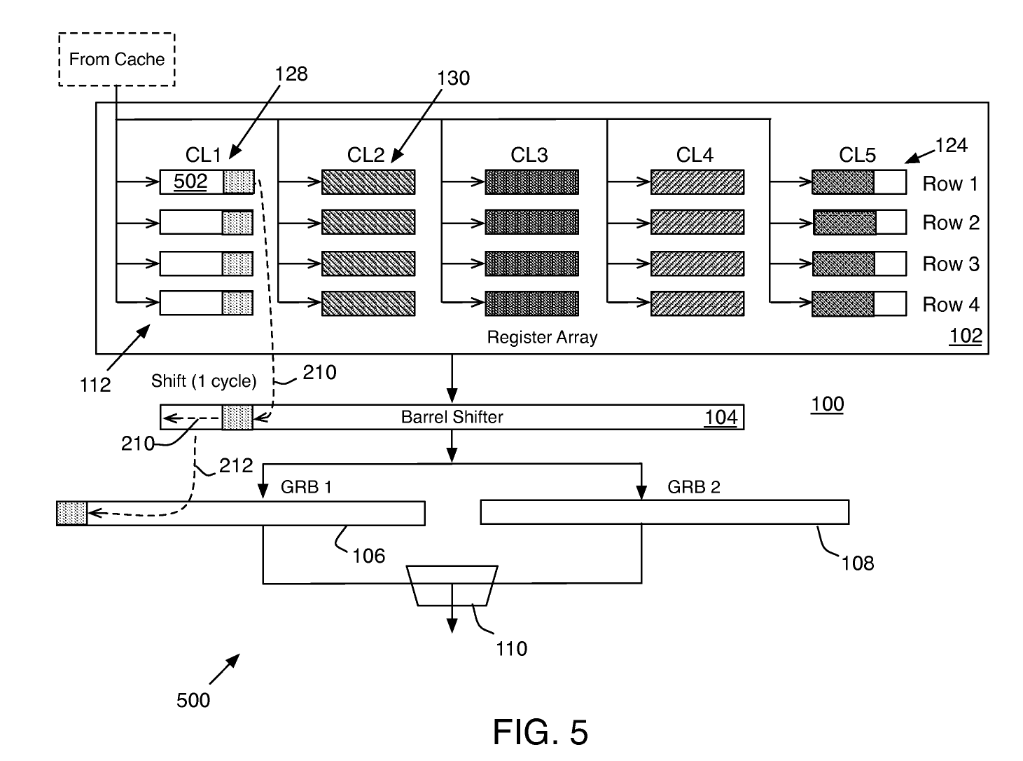

For example, FIG. 5 illustrates engine 100 in the context 500 of undertaking blocks 210 and 212 of process 200 for a first register portion in accordance with various implementations of the present disclosure. In context 500, five CLs of a ROI have been loaded in array 102 as shown where the contents of the ROI (shown by hashed markings) are not aligned with respect to array 102. In this example, the first CL of the ROI (e.g., CL1) has been loaded into the first tetris register 112 so that each portion 122 of tetris register 112 includes a non-valid portion 502. In accordance with the present disclosure, when block 210 is undertaken for the first register portion 128 of row 124, the contents of portion 128 are loaded in shifter 104 and left shifted so that when the contents are provided to GRB 106 at block 210 the data is aligned with GRB 106 as shown.

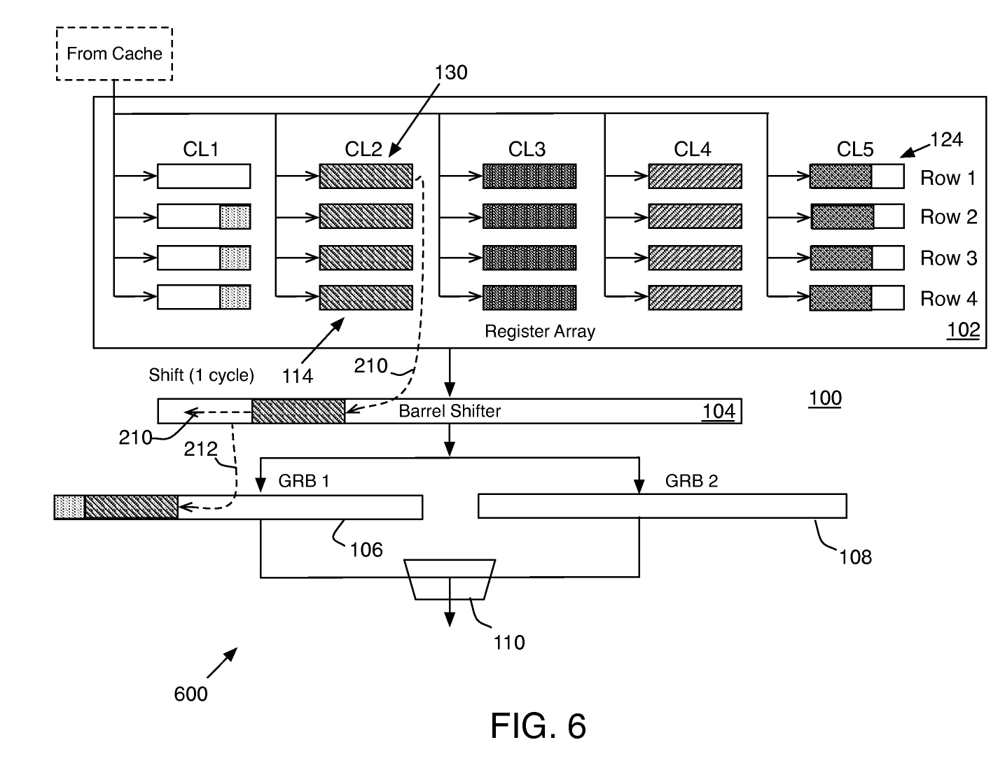

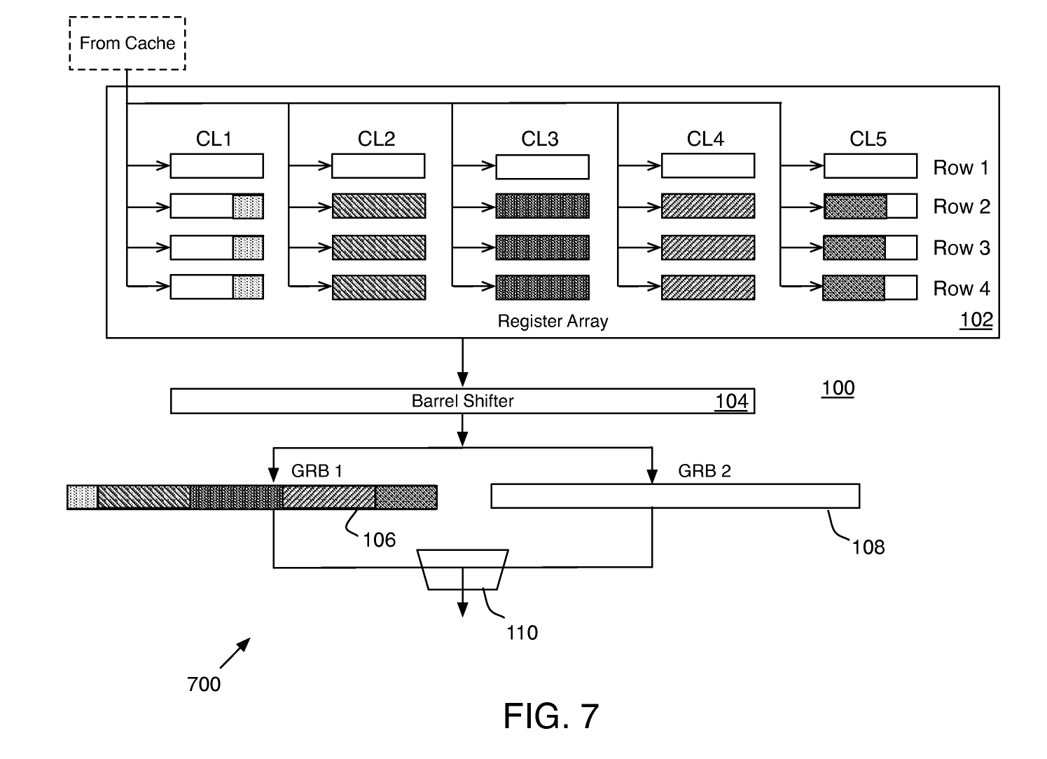

Continuing the example, FIG. 6 illustrates engine 100 in the context 600 of undertaking blocks 210 and 212 of process 200 for a next register portion in accordance with various implementations of the present disclosure. In context 600, blocks 210 and 212 are undertaken for next portion 130 of row 124 by loading the contents of portion 130 of tetris register 114 into shifter 104, left shifting the data and then providing the aligned data to GRB 106 so that it is stored adjacent to the aligned data from portion 128 as shown. In this manner, at the conclusion of blocks 210 and 212 the complete aligned contents of row 124 may be stored in GRB 106 as shown in FIG. 7 where engine 100 is illustrated in the context 700 of the completion of blocks 210 and 212 of process 200 for first register row 124 in accordance with various implementations of the present disclosure.

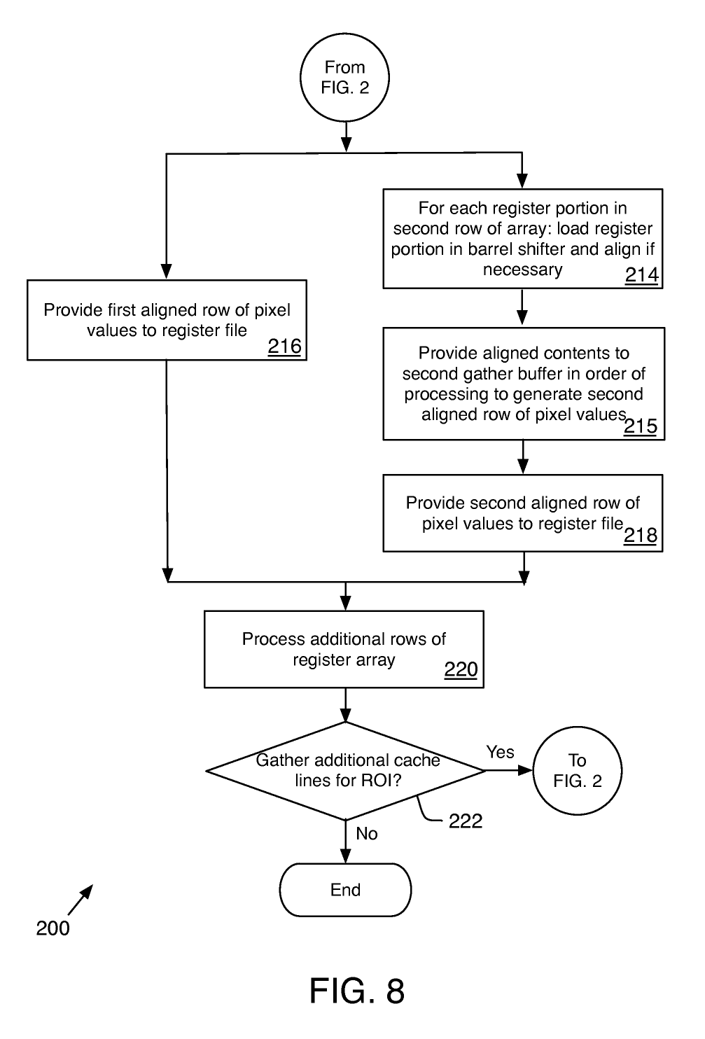

Returning to discussion of FIG. 2, when the aligned contents of the first row have been loaded in the first gather buffer at block 212, process 200 may continue with the processing of any additional rows of the register array. FIG. 8 illustrates a flow diagram of additional portions of example process 200 for implementing gather operations according to various implementations of the present disclosure. The additional portions of process 200 may include one or more operations, functions or actions as illustrated by one or more of blocks 215, 214, 216, 218, 220, and 222 of FIG. 8. By way of non-limiting example, the additional blocks of process 200 will also be described herein with reference to example gather engine 100 of FIG. 1. Process 200 may continue at block 214 of FIG. 8.

At block 214, contents of the portions of the second row of the array may be successively loaded into the barrel shifter and, if necessary, the contents may be aligned. At block 215 the aligned contents of the register portions may be merged in the second gather buffer. For example, blocks 214 and 215 may include loading the contents of first portion 132 of second row 126 in shifter 104, left shifting the data, loading the aligned data in GRB 108, loading the contents of second portion 134 of second row 126 in shifter 104, left shifting the data, loading the aligned data in GRB 108 next to the aligned data from portion 132, and so on until all portions of the second row have been processed. Thus, in this example, at the conclusion of blocks 214 and 215 the aligned contents of the second row 126 of register array 102 may be loaded in GRB 108.

While block 214 and/or 215 are occurring, the aligned contents of the first row may be provided from the first register buffer to a 2D register file at block 216. For example, block 216 may include using MUX 110 to provide the aligned first row data stored in GRB 106 to an RF where that data may be stored as a first row of data in the RF. At block 218, the aligned contents of the second row may be provided from the second register buffer to the RF. For example, block 218 may include using MUX 110 to provide the aligned second row data stored in GRB 108 to the RF where that data may be stored as a second row of data in the RF.

Process 200 may continue at block 220 with the processing of additional rows of the register array in a manner similar to that described above for the first two rows of the register array. Thus, for example, block 220 may result in the aligned content of the three remaining rows of array 102 being stored as the next three rows of data in the RF and the processing of those rows of the array may be completed. At block 222 a determination may be made regarding whether gathering of more cache lines for a the ROI should be undertaken. For example, if a first iteration of process 200 has resulted in gathering of four rows of a 64×64 ROI, gather operations may continue for a next four rows of the ROI. If gather operations are to continue for the ROI, process 200 may return to FIG. 2 and may be undertaken a second time for one or more additional cache lines of ROI beginning at block 201. Otherwise, if gather operations are not to continue, process 200 may end.

While the implementation of example processes 200, as illustrated in FIGS. 2 and 8, may include the undertaking of all blocks shown in the order illustrated, the present disclosure is not limited in this regard and, in various examples, implementation of processes 200 may include the undertaking only a subset of all blocks shown and/or in a different order than illustrated. For example, in various implementations, block 216 of FIG. 8 may be undertaken before during and/or after either or both of blocks 214 and 215. In addition, gather processing in accordance with the present disclosure may be undertaken for various fill stages of a register array so that if, at any one time, one or more rows of the register array are empty, those rows may be loaded with ROI pixel values from cache memory while array rows holding pixel values of the ROI are processed as described herein.

In addition, any one or more of the processes and/or blocks of FIGS. 2 and 8 may be undertaken in response to instructions provided by one or more computer program products. Such program products may include signal bearing media providing instructions that, when executed by, for example, one or more processor cores, may provide the functionality described herein. The computer program products may be provided in any form of computer readable medium. Thus, for example, a processor including one or more processor core(s) may undertake one or more of the blocks shown in FIGS. 2 and 8 in response to instructions conveyed to the processor by a computer readable medium.

Further, while process 200 has been described herein in the context of example gather engine 100 gathering 64 byte cache lines for a 64×64 ROI of a video surface stored in tile-y format in cache memory, the present disclosure is not limited to particular sizes of cache lines, sizes or shapes of ROIs, and/or to particular tiled memory formats. For example, to implement gather processing for ROIs having greater than 64 byte widths, one or more additional tetris registers may be added to the register array. In addition, for smaller width ROIs, such as, for example, a 32×64 ROI, the first two rows of the array may be collected into a gather buffer before being written out to the RF. Further, other tile memory formats, such as tile-x or the like, may be subjected to gather processing in accordance with the present disclosure

In various implementations, one or more processor cores may undertake process 200 data using engine 100 for any size and/or shape of ROI and for any alignment of the ROI data with respect to engine 100. In so doing, processor throughput may depend on the size, shape and/or alignment of the ROI. For instance, in a non-limiting example, one cache line may be processed in two cycles if the ROI to be gathered is stretched in the X direction (e.g., as a row of pixel values in a tile-y format) and fully aligned. In such circumstances the throughput may be limited by the cache memory bandwidth. On the other hand, if the ROI is stretched in the Y direction (e.g., as a column of pixel values in a tile-y format) and fully aligned, one cache line may be processed in sixty-four cycles. In another non-limiting example, one cache line may be processed in twelve cycles for a fully misaligned 17×17 ROI. In a final non-limiting example, pixel values of an aligned 24×24 ROI may be gathered in fifty cycles, while if the 24×24 ROI is completely misaligned it may take eighty-one cycles to gather all pixel values.

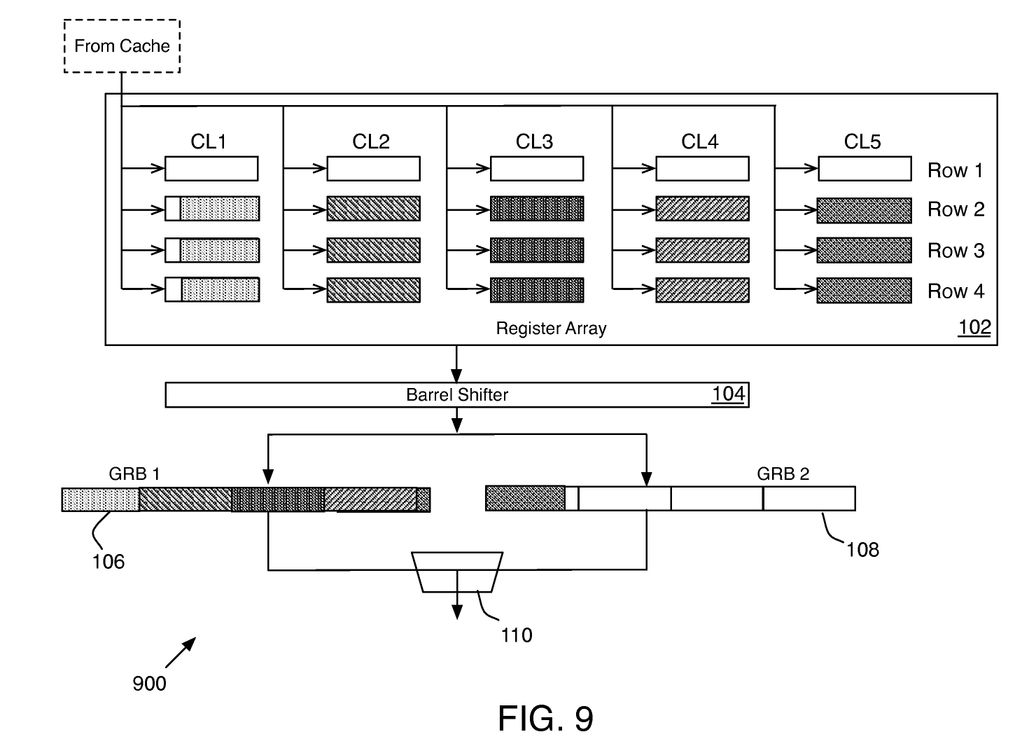

In various implementations, gather processes in accordance with the present disclosure may be undertaken in overflow conditions. For instance, referring to example gather engine 100, in some implementations a ROI may exceed the width of the barrel shifter 104 and GRBs 106 and 108. FIG. 9 illustrates engine 100 in the context 900 of undertaking process 200 in overflow conditions in accordance with various implementations of the present disclosure. As shown in FIG. 9, after filling GRB 106 with most of the first row, the overflow data 902 remaining from the first row may be placed in GRB 108. Processing of the remaining rows may continue in a similar manner.

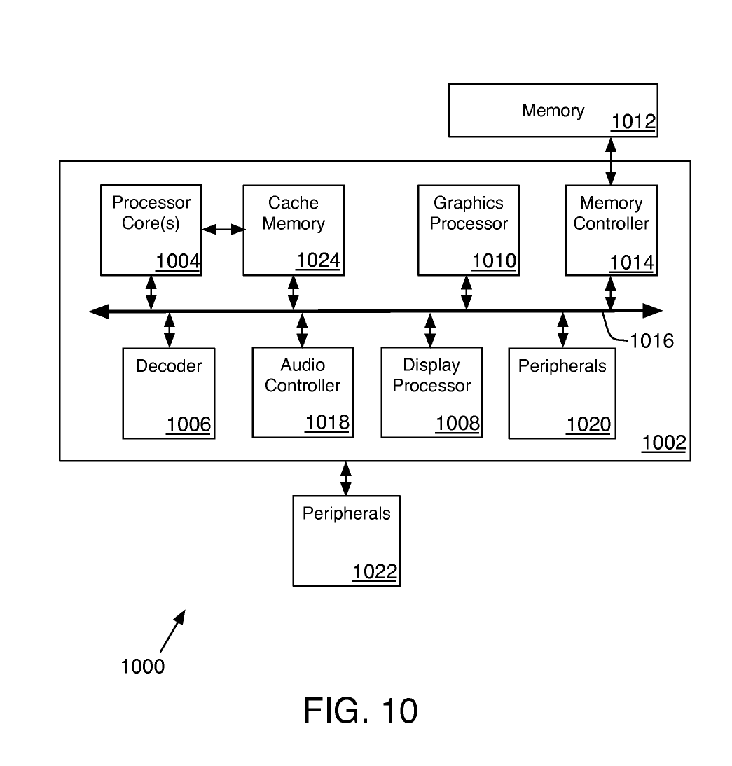

FIG. 10 illustrates an example system 1000 in accordance with the present disclosure. System 1000 may be used to perform some or all of the various functions discussed herein and may include any device or collection of devices capable of undertaking gather processing in accordance with various implementations of the present disclosure. For example, system 1000 may include selected components of a computing platform or device such as a desktop, mobile or tablet computer, a smart phone, a set top box, etc., although the present disclosure is not limited in this regard. In some implementations, system 1000 may be a computing platform or SoC based on Intel® architecture (IA) for CE devices. It will be readily appreciated by one of skill in the art that the implementations described herein can be used with alternative processing systems without departure from the scope of the present disclosure.

System 1000 includes a processor 1002 having one or more processor cores 1004. Processor cores 1004 may be any type of processor logic capable at least in part of executing software and/or processing data signals. In various examples, processor cores 1004 may include CISC processor cores, RISC microprocessor cores, VLIW microprocessor cores, and/or any number of processor cores implementing any combination of instruction sets, or any other processor devices, such as a digital signal processor or microcontroller. In various implementations, one or more of processor core(s) 1004 may implement gather engines and/or undertake gather processing in accordance with the present disclosure.

Processor 1002 also includes a decoder 1006 that may be used for decoding instructions received by, e.g., a display processor 1008 and/or a graphics processor 1010, into control signals and/or microcode entry points. While illustrated in system 1000 as components distinct from core(s) 1004, those of skill in the art may recognize that one or more of core(s) 1004 may implement decoder 1006, display processor 1008 and/or graphics processor 1010. In response to control signals and/or microcode entry points, display processor 1008 and/or graphics processor 1010 may perform corresponding operations.

Processing core(s) 1004, decoder 1006, display processor 1008 and/or graphics processor 1010 may be communicatively and/or operably coupled through a system interconnect 1016 with each other and/or with various other system devices, which may include but are not limited to, for example, a memory controller 1014, an audio controller 1018 and/or peripherals 1020. Peripherals 1020 may include, for example, a unified serial bus (USB) host port, a Peripheral Component Interconnect (PCI) Express port, a Serial Peripheral Interface (SPI) interface, an expansion bus, and/or other peripherals. While FIG. 10 illustrates memory controller 1014 as being coupled to decoder 1006 and the processors 1008 and 1010 by interconnect 1016, in various implementations, memory controller 1014 may be directly coupled to decoder 1006, display processor 1008 and/or graphics processor 1010.

In some implementations, system 1000 may communicate with various I/O devices not shown in FIG. 10 via an I/O bus (also not shown). Such I/O devices may include but are not limited to, for example, a universal asynchronous receiver/transmitter (UART) device, a USB device, an I/O expansion interface or other I/O devices. In various implementations, system 1000 may represent at least portions of a system for undertaking mobile, network and/or wireless communications.

System 1000 may further include memory 1012. Memory 1012 may be one or more discrete memory components such as a dynamic random access memory (DRAM) device, a static random access memory (SRAM) device, flash memory device, or other memory devices. Memory 1012 may store instructions and/or data represented by data signals that may be executed by the processor 1002. In some implementations, memory 1012 may include a system memory portion and a display memory portion. In various implementations, memory 1012 may store video data such as frame(s) of video data including pixel values that may, at various junctures, be stored as cache lines gathered by engine 100 and/or processed by process 200.

While FIG. 10 illustrates memory 1012 external to processor 1002, in various implementations, processor 1002 includes one or more instances of internal cache memory 1024 such as L1 cache memory. In accordance with the present disclosure, cache memory 1024 may store video data such as pixel values in the form of cache lines arranged in a tile-y format. Processor core(s) 1004 may access the data stored in cache memory 1024 to implement the gather functionality described herein. Further, cache memory 1024 may provide the 2D register file that stores the aligned data output of engine 100 and process 200. In various implementations, cache memory 1024 may receive video data such as pixel values from memory 1012.

The systems described above, and the processing performed by them as described herein, may be implemented in hardware, firmware, or software, or any combination thereof. In addition, any one or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including a computer readable medium having computer program logic stored therein to cause a computer system to perform one or more features and/or combinations of features disclosed herein.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

What is claimed:

1. An apparatus for gathering pixel values, comprising:
a plurality of tetris registers arranged as a register array, each tetris register including at least a first register portion and a second register portion, wherein a first row of the register array includes the first register portion of each tetris register, the register array to store a plurality of cache lines of pixel values so that the first row of the register array stores a most significant portion of each cache line;
a barrel shifter to receive, from the first row of the register array, the most significant portions of the plurality of cache line as a first row of pixel values, the barrel shifter to align the first row of pixel values; and
a first buffer to receive the aligned first row of pixel values from the barrel shifter.

2. The apparatus of claim 1, wherein a second row of the register array includes the second register portion of each tetris register, the register array to store the plurality of cache lines of pixel values so that the second row of the register array stores a next most significant portion of each of the cache lines, the barrel shifter to receive, from the second row of the register array, the next most significant portions of the plurality of cache lines as a second row of pixel values, the barrel shifter to align the second row of pixel values, the apparatus further comprising:
a second buffer to receive the aligned second row of pixel values from the barrel shifter.

3. The apparatus of claim 1, further comprising:
a multiplexer coupled to the first and second buffers; and
a register file coupled to the multiplexer, wherein the multiplexer is configured to provide either the aligned first row of pixel values or the aligned second row of pixel values to the register file, wherein the register file is configured to store the aligned second row of pixel values adjacent to the aligned first row of pixel values.

4. The apparatus of claim 1, wherein the most significant portion of each cache line comprises a row of pixel data in tile-y format.

5. The apparatus of claim 1, wherein each cache line comprises 64 bytes of pixel values, wherein the plurality of tetris registers includes at least five tetris registers, wherein each tetris register is configured to store 64 bytes of pixel values, and wherein the first register portion and the second register portion are each configured to store 16 bytes of pixel values.

6. The apparatus of claim 1, wherein to align the first row of pixel values the barrel shifter is configured to left shift the first row of pixel values.

7. A method for gathering pixel values, comprising:
receiving a plurality of cache lines;
apportioning each cache line into at least a most significant portion and a next most significant portion;
storing contents of the plurality of cache lines in a register array so that the most significant portion of each cache line is stored in a first row of the register array, the first row including a first plurality of register portions;
providing contents of a first register portion of the first plurality of register portions to a barrel shifter;
aligning the contents of the first register portion of the first plurality of register portions; and
storing the aligned contents of the first register portion of the first plurality of register portions in a first buffer.

8. The method of claim 7, wherein storing contents of the plurality of cache lines in the register array comprises storing contents the plurality of cache lines in the register array so that a next most significant portion of each cache line is stored in a second row of the register array, the second row including a second plurality of register portions, the method further comprising:
providing contents of a first register portion of the second plurality of register portions to the barrel shifter;
aligning the contents of the first register portion of the second plurality of register portions; and
storing the aligned contents of the first register portion of the second plurality of register portions in a second buffer.

9. The method of claim 8, further comprising:
providing the aligned contents of the first register portion of the first plurality of register portions to a register file before providing the aligned contents of the first register portion of the second plurality of register portions to the register file.

10. The method of claim 7, wherein the register array comprises a plurality of tetris registers.

11. The method of claim 7, wherein the register array comprises the plurality of tetris registers arranged such that a first portion of each tetris register stores the most significant portion of a corresponding one of the plurality of cache lines.

12. The method of claim 7, wherein aligning the contents of the first register portion of the first plurality of register portions comprises left-shifting the contents of the first register portion of the first plurality of register portions.

13. A system for gathering pixel values, comprising:
cache memory to store a plurality of cache lines of pixel values; and
a gather engine coupled to the memory, the gather engine to receive the plurality of cache lines from the memory, the gather engine including:
a plurality of tetris registers arranged as a register array, each tetris register including at least a first register portion and a second register portion, wherein a first row of the register array includes the first register portion of each tetris register, the register array to store the plurality of cache lines so that the first row of the register array stores a most significant portion of each cache line;
a barrel shifter to receive, from the first row of the register array, the most significant portions of the plurality of cache line as a first row of pixel values, the barrel shifter to align the first row of pixel values; and
a first buffer to receive the aligned first row of pixel values from the barrel shifter.

14. The system of claim 13, wherein a second row of the register array includes the second register portion of each tetris register, the register array to store the plurality of cache lines so that the second row of the register array stores a next most significant portion of each of the cache lines, the barrel shifter to receive, from the second row of the register array, the next most significant portions of the plurality of cache lines as a second row of pixel values, the barrel shifter to align the second row of pixel values, the apparatus further comprising:
a second buffer to receive the aligned second row of pixel values from the barrel shifter.

15. The system of claim 14, further comprising:
a multiplexer coupled to the first and second buffers; and
a register file coupled to the multiplexer, wherein the multiplexer is configured to provide either the aligned first row of pixel values or the aligned second row of pixel values to the register file, wherein the register file is configured to store the aligned second row of pixel values adjacent to the aligned first row of pixel values.

16. The system of claim 13, wherein the cache memory is configured to store the cache lines in a tile-y format.

17. The system of claim 13, wherein each cache line comprises 64 bytes of pixel values, wherein the plurality of tetris registers includes at least five tetris registers, wherein each tetris register is configured to store 64 bytes of pixel values, and wherein the first register portion and the second register portion are each configured to store 16 bytes of pixel values.

18. The system of claim 13, wherein to align the first row of pixel values the barrel shifter is configured to left shift the first row of pixel values.

19. The system of claim 13, further comprising memory to store video data, the memory configured to provide portions of the video data to the cache memory for storage as the plurality of cache lines.
